(19) United States
(12) Patent Application Publication
(10) Pub. No.: US 2009/0213735 A1
(43) Pub. Date: Aug. 27, 2009

(54) SYSTEM TO IMPROVE DATA PACKET ROUTING IN A DATA PROCESSING DEVICE AND ASSOCIATED METHODS

(76) Inventors: Mark A. Check, Hopewell Junction, NY (US); Michael Grassi, Shokan, NY (US); Scot H. Rider, Pleasant Valley, NY (US); Gabriel M. Tarr, Poughkeepsie, NY (US)

Correspondence Address: INTERNATIONAL BUSINESS MACHINES CORPORATION;Richard Lau, IPLAW DEPARTMENT / Bldg 008-2, 2455 SOUTH ROAD - MS P386, POUGHKEEPSIE, NY, 12601, US

(21) Appl. No.: 12/037,065

(22) Filed: Feb. 25, 2008

(51) Int. Cl. H04L 12/58

(52) U.S. Cl. 370/236

(57) ABSTRACT

A system to improve data packet routing in a data processing device may include a plurality of functional modules, and communication buses connecting the functional modules. The system may also include a flow control mechanism in which command packets that traverse the communication buses are each assigned their own channel with their own pool of credits. The system may further include a switch to route data packets on the communication buses from one of the functional modules to any other of the functional modules based upon the credits. In addition, any of the functional modules without credits to send the data packets on a particular channel may send a message to have the switch perform a route test.

### FIELD OF THE INVENTION

The invention relates to the field of computer systems, and, more particularly, to data interfaces between different components of a data processing device.

### BACKGROUND OF THE INVENTION

Many data processing device components are implemented on integrated circuit chips. Improvements in the manufacture and design of integrated circuitry have made it possible to place a very large number of active devices, such as transistors, on a single integrated circuit chip. This in turn makes it possible for a single chip to perform complex functions of a data processing device. For some years now, it has been possible to implement a complete central processing unit (“CPU”) on a single integrated circuit chip, and more recent CPUs contain on-chip caches and other components.

Other integrated circuit chips are used to perform custom functions, such as memory device controllers, input/output device controllers, bus controllers, adapters and repeaters, and so forth. An application-specific integrated circuit is one example.

In any computer system or other data processing device, there is a need to provide communications paths, generally called buses, for interconnecting various components of the system. Buses can be used to provide communications among different integrated circuit chips, or among different internal components of a single integrated circuit chip. The characteristics of these buses vary depending on the uses to which they will be put. For example, the volume of data traversing a bus, the physical length of the bus, the types of devices attached to the bus, and so forth will affect bus design.

Because many different types of devices may be attached to a bus, each operating at a different speed, performing a different function, and located in a different location, a bus generally provides a flow control mechanism which prevents data from being sent by a first device when a second device is not ready. For example, a flow control mechanism may be a “not ready” signal that indicates the receiving device is not ready to receive data, or a “retry” signal that rejects data transactions the receiver cannot accept.

One known form of flow control mechanism is a credit-based control mechanism, whereby a sending device receives an allocation of credits to transmit data on the bus. Credits may represent buffer capacity in the receiver, or some other form of capability of the receiver to receive data. When the sender transmits data on the bus, it decrements its allocation of credits. When the receiver restores the capacity to receive additional data, it returns the credit to the sender. The sender is thus allowed to transmit data immediately on the bus, without asking permission of the receiver, so long as it has credits available. If the sender ever runs out of credits, it is temporarily prevented from sending additional data to the receiver.

Examples of such a system is found in U.S. Pat. No. 7,249,207 entitled “Internal data bus interconnection mechanism utilizing central interconnection module converting data in different alignment domains” and U.S. Pat. No. 7,136,954 entitled “Data communication method and apparatus utilizing credit-based data transfer protocol and credit loss detection mechanism”, as well as co-pending U.S. patent application Ser. No. 11/047,548 entitled “Data Communication Method and Apparatus Utilizing Programmable Channels for Allocation of Buffer Space and Transaction Control” and U.S. patent application Ser. No. 11/047,549 entitled “Internal Data Bus Interconnection Mechanism Utilizing Shared Buffers Supporting Communication Among Multiple Functional Components of an Integrated Circuit Chip”, the entire subject matters of which are incorporated herein by reference in their entirety. The aforementioned applications are assigned to the same assignee as this application, International Business Machines Corporation of Armonk, N.Y.

### SUMMARY OF THE INVENTION

In view of the foregoing background, it is an object of the invention to provide a system that improves the communications network between the various components of a data processing device.

This and other objects, features, and advantages in accordance with the invention are provided by a system to improve data packet routing in a data processing device. The system may include a plurality of functional modules, and communication buses connecting the functional modules. The system may also include a flow control mechanism in which command packets that traverse the communication buses are each assigned their own channel with their own pool of credits. The system may further include a switch to route data packets on the communication buses from one of the functional modules to any other of the functional modules based upon the credits. In addition, any of the functional modules without credits to send the data packets on a particular channel may send a message to have the switch perform a route test.

The switch may return an availability indicator based upon the route test. The plurality of functional modules without credits to send the data packets may send the data packets on a different channel before the switch returns the availability indicator. Alternately, any of the functional modules without credits to send the data packets may send the data packets on the particular channel if a credit for the particular channel becomes available before the switch returns the availability indicator.

Further, any of the functional modules without credits to send the data packets may return to normal operation if the data packets have not been sent and the availability indicator shows the particular channel is blocked. Or, any of the functional modules without credits to send the data packets may send the data packets if the data packets have not been sent and the availability indicator shows the particular channel is unblocked.

The communication buses may each include an application-specific integrated circuit interconnect bus. The functional modules may include an electronic logic circuit and/or electronic storage.

Another aspect of the invention is a method to improve data packet routing in a data processing device. The method may include connecting a plurality of functional modules via communication buses, and assigning each command packet that traverses the communication buses its own channel with its own pool of credits.

The method may also include routing data packets on the communication buses from one of the functional modules to any other of the functional modules based upon the credits. In addition, the method may further include requesting a route test by any of the plurality of functional modules without credits to send the data packets on a particular channel.

### BRIEF DESCRIPTION OF THE DRAWINGS

FIG. 1 is a schematic block diagram of a system to improve packet routing in accordance with the invention.

FIG. 2 is a flowchart illustrating method aspects according to the invention.

FIG. 3 is a schematic block diagram of a prophetic example system in accordance with the invention of FIG. 1.

FIG. 4 illustrates a speculation state machine for a sending functional module in accordance with the invention of FIG. 1.

FIG. 5 illustrates a speculation state machine for a switch in accordance with the invention of FIG. 1.

FIG. 6 illustrates signals used the speculation function in accordance with the invention of FIG. 1.

FIG. 7 depicts one embodiment of an article of manufacture incorporating one or more aspects of the invention.

### DETAILED DESCRIPTION OF THE PREFERRED EMBODIMENTS

The invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

As will be appreciated by one skilled in the art, the invention may be embodied as a method, system, or computer program product. Furthermore, the invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, or a magnetic storage device.

Computer program code for carrying out operations of the invention may be written in an object oriented programming language such as Java, Smalltalk, C++ or the like. However, the computer program code for carrying out operations of the invention may also be written in conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

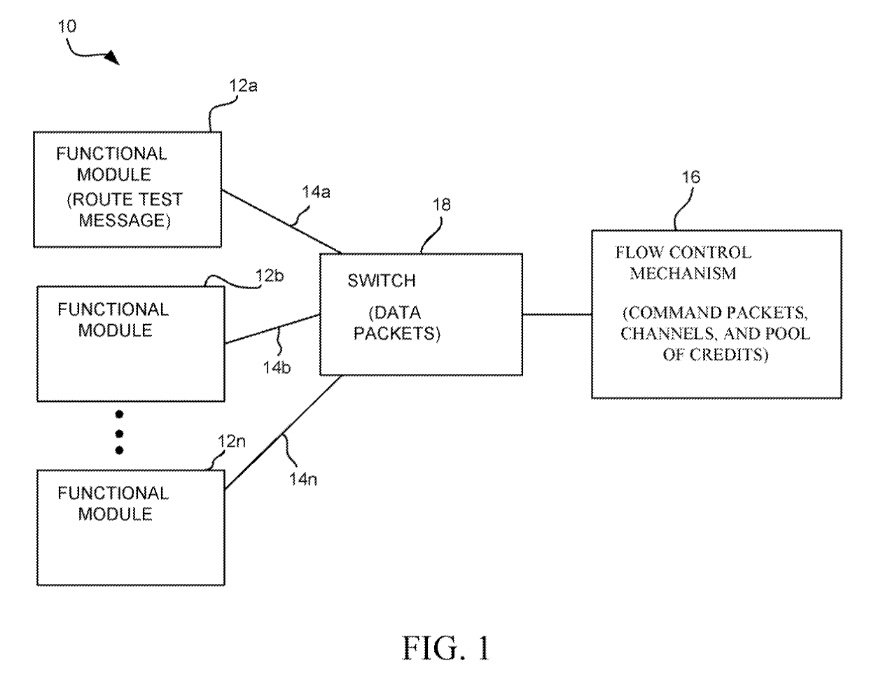

Referring to FIG. 1, a system 10 to improve data packet routing in a data processing device is initially described. The system 10 includes a plurality of functional modules 12a-12n, for example. In one embodiment, the functional modules 12a-12n include an electronic logic circuit such as an arithmetic logic unit, an integrated circuit, or the like. In another embodiment, the functional modules 12a-12n includes electronic storage such as cache memory, main memory, or the like. In yet another embodiment, the functional modules 12a-12n includes a combination of both of the previous embodiments.

The system 10 also includes communication buses 14a-14n connecting the functional modules 12a-12n as will be appreciated by those of skill in the art. In one embodiment, the communication buses 14a-14n each comprise an application-specific integrated circuit interconnect bus (“AIB”).

The system further includes a flow control mechanism 16 in which command packets that traverse the communications bus are each assigned their own channel with their own pool of credits, for example. The command packets may be command only packets and/or command with data packets. One embodiment of the flow control mechanism 16 is described in the foregoing background section.

The system additionally includes a switch 18 to route data packets on the communication bus 14a-14n from one of the functional modules 12a-12n to any other of the functional modules based upon the credits, for instance. The credits can be a command credit and/or a data credit.

In one embodiment, any of the functional modules 12a-12n without credits to send the data packets on a particular channel may send a message to have the switch 18 perform a route test. For example, the zero credit being speculated on by the route test may be a command credit and/or a data credit problem. In another embodiment, the switch 18 returns an availability indicator based upon the route test.

The plurality of functional modules 12a-12n without credits to send the data packets sends the data packets on a different channel before the switch 18 returns the availability indicator, for example. Alternately, any of the functional modules 12a-12n without credits to send the data packets may send the data packets on the particular channel if a credit for the particular channel becomes available before the switch 18 returns the availability indicator.

In one embodiment, any of the functional modules 12a-12n without credits to send the data packets returns to normal operation if the data packets have not been sent and the availability indicator shows the particular channel is blocked. In another embodiment, any of the functional modules 12a-12n without credits to send the data packets may send the data packets if the data packets have not been sent and the availability indicator shows the particular channel is unblocked.

In view of the foregoing, the system 10 improves data packet routing in a data processing device by moving packets across a bus interface, called AIB, that is credit based. Further, a packet is moved to the target of the bus interface that has credits when another different target is full and causing zero credits to be reflected to the sender across the bus interface.

Before our invention on this credit based bus interface when configured for a single sender to be able to target multiple receivers with packets in which the sender does not know about how many or the details of the receivers that are attached in which the routing is performed by the bus interconnect when any given receiver was full and could not reflect any credits to the bus router fabric the bus fabric would need to reflect no credits back to the sender. If the sender had a packet that was destined for the unknown receiver destination that had available credits but that another destination did not the packet would not be possible to be placed on the fabric to be delivered.

In this the bus called AIB packets are mapped to a set of channels and each channel has its own set of available credits defined. In order to obtain high bandwidth applications the sender may only send a packet when there are available credits in the channel the command packet is mapped to. The central bus fabric sees all the available receivers attached and their available credits and has internal buffering allocated per channel. The central bus fabric reflects to the sender the available credits by channel based on each of the receivers and internal buffering available.

When no credits are available for a given channel no command may be sent in that map to that channel. The sender does not know which receiver is full and has caused there to be no available credits.

In order for each block to be usable in many chip design configurations the sender block does not know how many or the characteristics of any of the receivers. Only the central interconnect fabric is aware of the number and characteristics of each receiver and how to route packets to and from them on a chip by chip application basis.

The shortcomings of the prior art are overcome and additional advantages are provided through the provision of speculation. In speculation the sender of a packet to the bus interface may perform a test or speculation route on a command packet to the bus when the bus has no available credit for the channel that command is on.

The command is not really routed to the correct receiver, rather only that the bus fabric tests to see if the intended receiver in fact does have credits available and that the command that is speculated may in fact be able to reach the desired receiver. Once the bus fabric informs the sender that is possible to route the speculated packet to the receiver if no changes to the credits occur on that channel, then the sender may again send that same command packet in again even without credit and the bus fabric will route it to the desired receiver. This mechanism then allows that a command that would otherwise be stalled to an intended destination because of a lack of credits may in fact be routed to the desired destination and thus avert the blocking condition.

In the normal operation of this bus called AIB the sender may not send a packet to the bus fabric unless command and if required data credits are available. Doing so may incur an error condition and the packet may be lost. Thus in the normal operation of such a credit based bus where the sender is only told by the bus fabric of the amalgamation of available credit among all destinations and not the details of each destination a single packet type may be stalled by one destination to all destinations. The speculation operation allows the sender to send in a packet for route to an available destination without knowing to which destination the packet is destined or the details of that destinations available credit.

In the prior art, the failure (due to malfunction, etc.) of any single receiving component could render the other receiving components unavailable to the system, since traffic to the failed component would back up through the switch and eventually prevent the sending component from sending anything at all to the switch. The speculation invention provides the sending component with a mechanism to send traffic to the remaining functional receiving components while the failing component is recovered or restored to working order. This constitutes a reliability and availability enhancement.

In such a switched fabric system, it is not uncommon, during normal operation under heavy load, for a single receiving component to become temporarily stalled. In the prior art, this would stall traffic to the other receiving components as well. With the invention of speculation, traffic may still flow to the other, non-stalled, receiving components. This constitutes a performance enhancement.

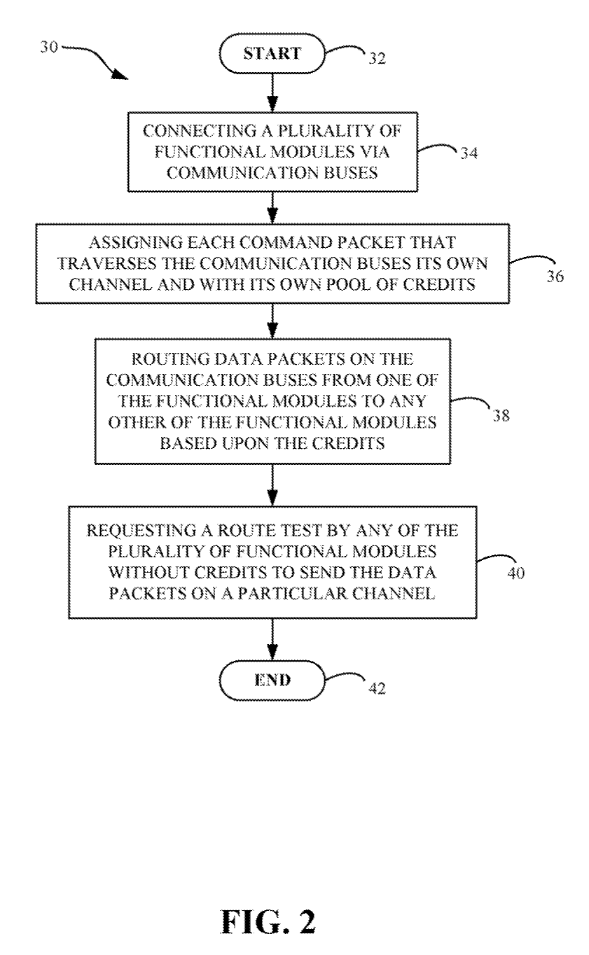

Another aspect of the invention is directed to a method to improve data packet routing in a data processing device, which is now described with reference to flowchart 30 of FIG. 2. The method begins at Block 32 and may include connecting a plurality of functional modules via a communications bus at Block 34. The method may also include assigning each command packet that traverses the communications bus its own channel with its own pool of credits at Block 36.

The method may further include routing data packets on the communications bus from one of the functional modules to any other of the functional modules based upon the credits at Block 38. In addition, the method may include requesting a route test by any of the plurality of functional modules without credits to send the data packets on a particular channel at Block 40. The method ends at Block 42.

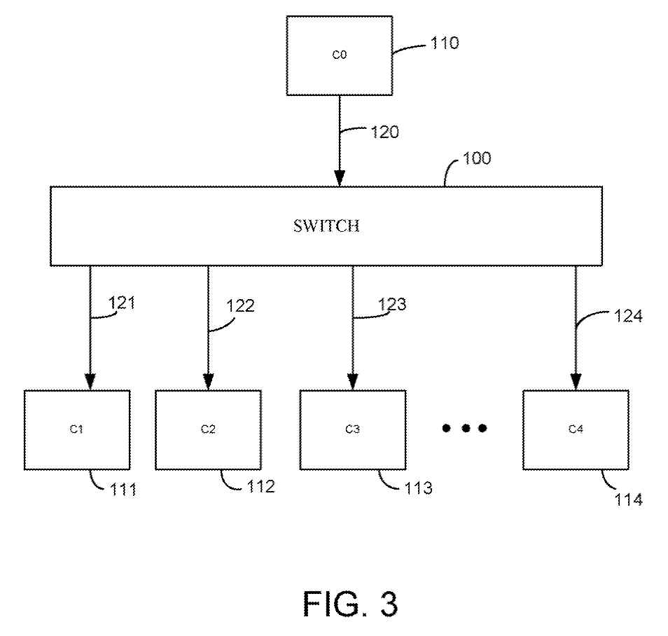

A prophetic example of how the system 10 may work is now described with additional reference to FIGS. 3-6. In FIG. 3 there is a fabric switch (100) that performs the routing of command packets from a sending functional module C0, (110) to any number of possible receiving functional modules C1-C4 (111, 112, 113, and 114). This is done over an interface bus I0 (120) called AIB from the sender to the fabric and then to a single destination receiver over one of the standard interface buses I1-I4 (121, 122, 123, or 124) also called an AIB bus.

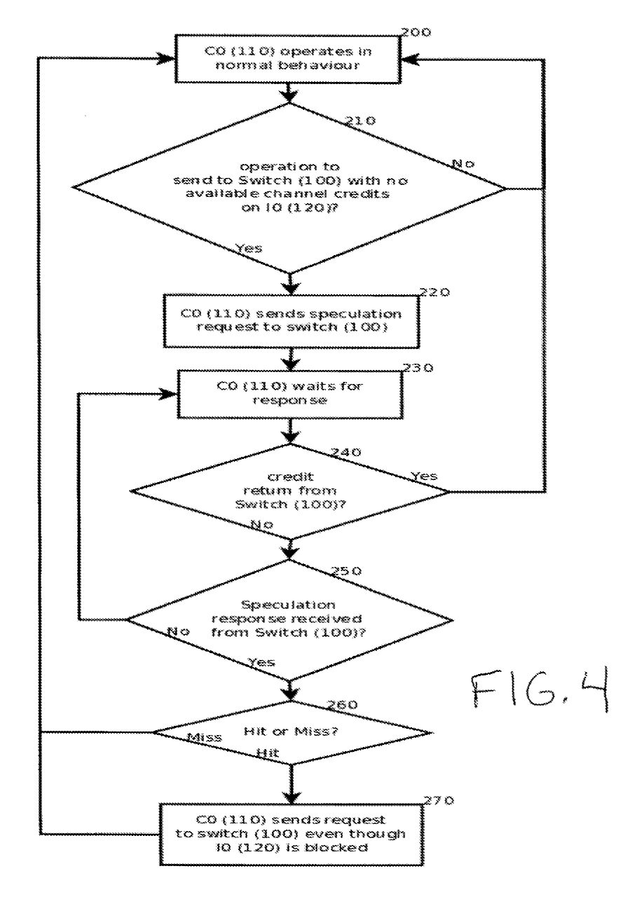

FIG. 4 illustrates the speculation state machine of the sending functional module C0 (110). The loop through steps 200 and 210 illustrates functional module C0 (110) operating in normal mode, with credits available for the operations it has to send (or no operations to send at all). When functional module C0 (110) has an operation to send with no available credits on that channel, then it proceeds to step 220 in which functional module C0 (110) sends an operation to the switch (100) with a special marking that indicates the switch (100) should perform a test route and return an availability indicator to functional module C0 (110). This is referred to as the speculation request.

After sending the speculation request, functional module C0 (110) proceeds to step 230 in which it waits for a response from the switch (100). During this time, functional module C0 (110) is still free to send traffic on any other channels if it so chooses. If at any time while waiting for a speculation response, a credit is returned on the blocked channel, then functional module C0 (110) resets its speculation state machine and simply uses the returned credit. This is indicated by the decision step 240.

When functional module C0 (110) receives an answer from the switch (100), then functional module C0 (110) moves to step 260. If the response was a “miss” indicating the speculation request routed to a blocked component, then functional module C0 (110) returns to normal operation (200). If the response was a “hit” indicating the speculation request routed to a component with credits available, then functional module C0 (110) is free to send the request to the switch (100) even though there are no credits on AIB interface I0 (120). After doing so, functional module C0 (110) returns to normal operation (200).

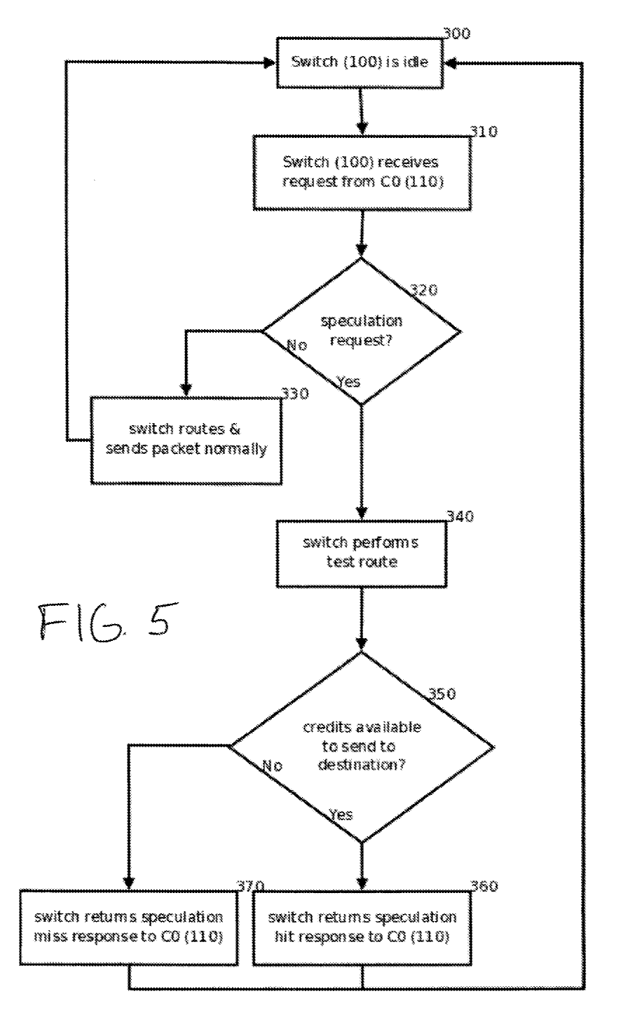

FIG. 5 illustrates the speculation state machine of the fabric switch (100). In step 300, the switch (100) is idle. Upon receiving an operation from the sending functional module C0 (110), the switch (100) moves through step 310 to step 320.

In step 320, the switch (100) examines the operation and determines if it is a normal request, or a speculation request. If a normal request, the switch (100) handles the packet normally (step 330), and then returns to the idle state (300). If the request is a speculation request, then the switch (100) moves to step 340 in which it performs a test route on the operation.

In step 350, the switch (100) examines the results of the test route to see if the operation routes to a blocked port (with no credits), or to a non-blocked port (with available credits). If the operation routes to a non-blocked port, the switch (100) moves to step 360, returning a speculation “hit” response to functional module C0 (110) before returning to idle state (300). If the operation routes to a blocked port, the switch (100) moves to step 370, returning a speculation “miss” response to functional module C0 (110) before returning to idle state (300).

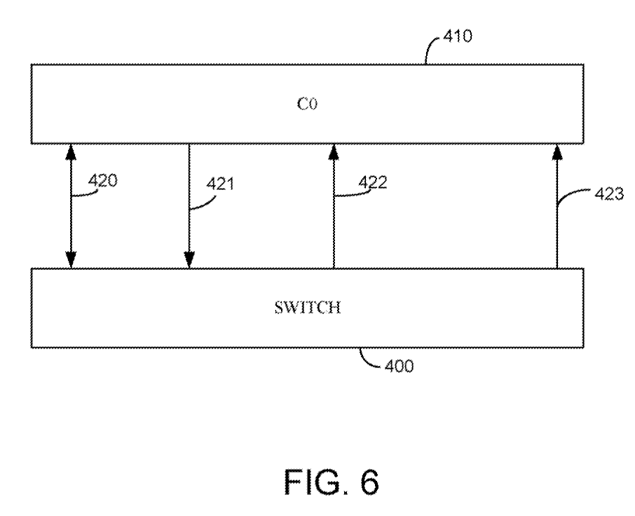

FIG. 6 illustrates the new AIB bus interface signals added to support the speculation function. The bidirectional arrow (420) represents previously existing AIB control signals. The arrow (421) from functional module C0 (410) to the Switch (400) is the new signal which functional module C0 (410) uses to tell the switch (400) that a request is a speculation request and not a normal request.

This signal (421) is active coincident with the existing AIB interface signals (420). The signals (422 and 423) from the switch (400) to functional module C0 (410) are the signals the switch (400) uses to respond with a “hit” or “miss” response respectively.

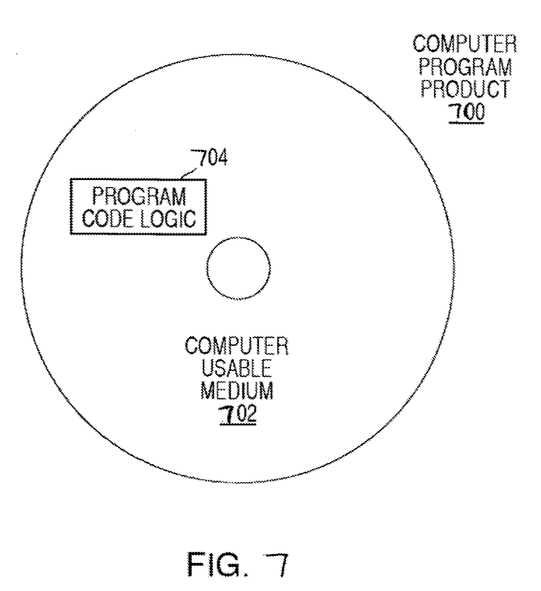

Another aspect of the invention is directed to embodiments that can be embodied in the form of computer-implemented processes and apparatuses for practicing those processes, which is now described with reference to FIG. 7. For example, the system 10 is embodied in computer program code executed by one or more network elements.

Embodiments include a computer program product 700 as depicted in FIG. 7 on a computer usable medium 702 with computer program code logic 704 containing instructions embodied in tangible media as an article of manufacture. Exemplary articles of manufacture for computer usable medium 702 may include floppy diskettes, CD-ROMs, hard drives, universal serial bus (USB) flash drives, or any other computer-readable storage medium, wherein, when the computer program code logic 704 is loaded into and executed by a computer, the computer becomes an apparatus for practicing the invention.

Embodiments include computer program code logic 704, for example, whether stored in a storage medium, loaded into and/or executed by a computer, or transmitted over some transmission medium, such as over electrical wiring or cabling, through fiber optics, or via electromagnetic radiation, wherein, when the computer program code logic 704 is loaded into and executed by a computer, the computer becomes an apparatus for practicing the invention. When implemented on a general-purpose microprocessor, the computer program code logic 704 segments configure the microprocessor to create specific logic circuits.

Additionally, at least one program storage device readable by a machine, tangibly embodying at least one program of instructions executable by the machine to perform the capabilities of the system 10 can be provided. The article of manufacture can be included as a part of a computer system or sold separately.

The capabilities of the system 10 can be implemented in software, firmware, hardware or some combination thereof.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention. Furthermore, the use of the terms a, an, etc. do not denote a limitation of quantity, but rather denote the presence of at least one of the referenced item.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

That which is claimed is:

1. A system to improve data packet routing in a data processing device, the system comprising:
a plurality of functional modules;
communication buses connecting said plurality of functional modules;
a flow control mechanism in which command packets that traverse said communication buses are each assigned their own channel with their own pool of credits; and
a switch to route data packets on said communication buses from one of said plurality of functional modules to any other of said plurality of functional modules based upon the credits;
wherein any of said plurality of functional modules without credits to send data packets on a particular channel can send a message to said switch to perform a route test.

2. The system of claim 1 wherein said switch returns an availability indicator based upon the route test.

3. The system of claim 2 wherein any of said plurality of functional modules without credits to send the data packets can send the data packets on a different channel before said switch returns the availability indicator.

4. The system of claim 2 wherein any of said plurality of functional modules without credits to send the data packets can send the data packets on the particular channel if a credit for the particular channel becomes available before said switch returns the availability indicator.

5. The system of claim 2 wherein any of said plurality of functional modules without credits to send the data packets returns to normal operation if the data packets have not been sent and the availability indicator shows the particular channel is blocked.

6. The system of claim 2 wherein any of said plurality of functional modules without credits to send the data packets sends the data packets if the data packets have not been sent and the availability indicator shows the particular channel is unblocked.

7. The system of claim 1 wherein said communication buses each comprise an application-specific integrated circuit interconnect bus.

8. The system of claim 1 wherein each of said plurality of functional modules comprises at least one of an electronic logic circuit and an electronic storage.

9. A method to improve data packet routing in a data processing device, the method comprising:
connecting a plurality of functional modules via communication buses;
assigning each command packet that traverses the communication buses its own channel with its own pool of credits;
routing data packets on the communication buses from one of the plurality of functional modules to any other of the plurality of functional modules based upon the credits; and
requesting a route test by any of the plurality of functional modules without credits to send the data packets on a particular channel.

10. The method of claim 9 wherein the route test determines an availability indicator.

11. The method of claim 10 wherein any of the plurality of functional modules without credits to send the data packets can send the data packets on a different channel before the availability indicator is determined.

12. The method of claim 10 wherein any of the plurality of functional modules without credits to send the data packets can send the data packets on the particular channel if a credit for the particular channel becomes available before the availability indicator is determined.

13. The method of claim 10 wherein any of the plurality of functional modules without credits to send the data packets returns to normal operation if the data packets have not been sent and the availability indicator shows the particular channel as being blocked.

14. The method of claim 10 wherein any of the plurality of functional modules without credits to send the data packets sends the data packets if the data packets have not been sent and the availability indicator shows the particular channel as being unblocked.

15. A computer program product embodied in a tangible media comprising:
computer readable program codes coupled to the tangible media to improve data packet routing in a data processing device, the computer readable program codes configured to cause the program to:
connect a plurality of functional modules via communication buses;
assign each command packet that traverses the communication buses its own channel with its own pool of credits;
routing data packets on the communication buses from one of the plurality of functional modules to any other of the plurality of functional modules based upon the credits; and
requesting a route test by any of the plurality of functional modules without credits to send the data packets on a particular channel.

16. The computer program product of claim 15 further comprising program code configured to: determine an availability indicator from the route test.

17. The computer program product of claim 16 further comprising program code configured to: send the data packets on a different channel before the availability indicator is determined for any of the plurality of functional modules without credits to send the data packets.

18. The computer program product of claim 16 further comprising program code configured to: send the data packets on the particular channel if a credit for the particular channel becomes available before the availability indicator is determined for any of the plurality of functional modules without credits to send the data packets.

19. The computer program product of claim 16 further comprising program code configured to: return to normal operation if the data packets have not been sent and the availability indicator shows the particular channel as being blocked for any of the plurality of functional modules without credits to send the data packets.

20. The computer program product of claim 16 further comprising program code configured to: send the data packets if the data packets have not been sent and the availability indicator shows the particular channel as being unblocked for any of the plurality of functional modules without credits to send the data packets.
